(19) United States
(12) Patent Application Publication
(10) Pub. No.: US 2006/0028962 A1
(43) Pub. Date: Feb. 9, 2006

(54) Method and system for encoding and detecting optical information

(76) Inventors: Oron Zachar, Tel Aviv (IL); Masud Mansuripur, Tucson, AZ (US)

Correspondence Address: Simon Kahn;c/o LandonIP, Inc., Suite 450, 1700 Diagonal Road, Alexandria, VA, 22314-2866, US

(21) Appl. No.: 11/189,857

(22) Filed: Jul. 27, 2005

Related U.S. Application Data
(60) Provisional application No. 60/598,840, filed on Aug. 5, 2004.
(60) Provisional application No. 60/650,964, filed on Feb. 9, 2005.
(60) Provisional application No. 60/674,300, filed on Apr. 25, 2005.

(51) Int. Cl. G11B 7/00

(52) U.S. Cl. 369/112.01

(57) ABSTRACT

An optical storage medium designed to be readable with light of a pre-determined wavelength, the optical storage medium comprising: a substrate; and a plurality of optically detectable marks imprinted on the substrate, each of the plurality of optically detectable marks exhibiting: a predetermined length; a width less than the pre-determined wavelength; and one of a plurality of orientations in relation to a common axis, wherein information is stored on the optical storage medium at least partially as a function of the one of a plurality of orientations. Preferably the optically detectably marks alter the polarization characteristics of an incident polarized light of the pre-determined wavelength, the altered polarization characteristics being detectable by at least one detector.

### CROSS-REFERENCE TO RELATED APPLICATIONS

This application claims priority from provisional patent application Ser. No. 60/598,840 filed Aug. 5, 2004 entitled “Method and Apparatus for Optical Data Storage” the entire contents of which are incorporated herein by reference; provisional patent application Ser. No. 60/650,964 filed Feb. 9, 2005 entitled “Methods for Encoding and Detection of Information in Multi-state Pit Marks” the entire contents of which are incorporated herein by reference; and provisional patent application Ser. No. 60/674,300 filed Apr. 25, 2005 entitled “Methods and System for Encoding and Optical Detection of Information” the entire contents of which are incorporated herein by reference.

### BACKGROUND OF THE INVENTION

The invention relates generally to the field of optical data storage and in particular to a means for increased data storage based on pit orientation.

The increasing need for data storage has been a consistent driver for expanding the data density of various media. Optical storage has recently become very common, with a standard optical compact disc (CD) having a typical capacity of over 750 megabits. Digital video disc (DVD) technology is also common, having a capacity of around 4.7 gigabits, and technologies enabling discs with capacity of 25-50 gigabits have recently been introduced.

In the above technologies a light source, such as a laser diode, is used to read a pattern of marks written on a substrate. Typically a low cost red light laser is preferred, although advanced technologies utilizing a blue laser for increased storage density have been introduced. Marks typically comprise pits or bulges written on a substrate, and are encoded in a binary pattern.

The use of a binary pattern simplifies the detection and proper translation of the mark, but it also limits the amount of data storage that can be supplied in a given data media. Furthermore, the use of a binary pattern negatively impacts the ultimate data reading rate. Data storage is ultimately limited by the size of the mark, and the ability to differentiate between adjacent marks. An increase in data density typically leads to an increase in the ultimate data reading rate. High Definition Television (HDTV) requires a data read rate on the order of 18 Mb/s, which is well above the current capabilities of red laser based DVD technology.

Increased density is available by utilizing a blue light laser source having a shorter wavelength than the commonly utilized red light laser source, however this results in increased costs. Furthermore, the use of a blue light laser source does not optimize storage on a given media, since the use of a binary coding method places a limitation on the amount of data that may be stored.

Encoding methods other than binary are known in the art and have been suggested in inter alia U.S. Pat. No. 5,144,615 entitled “APPARATUS AND METHOD FOR RECORDING AND REPRODUCING MULTILEVEL INFORMATION” issued to Kobayashi and U.S. Pat. No. 6,657,933 entitled “METHOD AND APPARATUS FOR READING AND WRITING A MULTILEVEL SIGNAL FROM AN OPTICAL DISC” issued to Wong et al, the contents of both of which are incorporated herein by reference. Reproduction of the multi-level recording states is a result of decoding the varying light intensity of a reflected or transmitted light source. Unfortunately, in practice the use of multi-level encoding has been found to be somewhat difficult, and has not satisfactorily maximized the storage on the optical media.

U.S. Pat. No. 5,453,969 entitled “OPTICAL MEMORY WITH PIT DEPTH ENCODING” issued to Psaltis et al is addressed to an optical storage medium constituting a substrate imprinted with optically detectable pits, each of the pits having one of a set of predetermined pit depths. Varying the pit depth enables an improved encoding density. Unfortunately, this has not been commercially successful, at least partially due to the difficulty in obtaining good resolution. Furthermore, it would be desirable to have a method of encoding which enables a further increase in density.

U.S. Pat. No. 5,880,838 entitled “SYSTEM AND METHOD FOR OPTICALLY MEASURING A STRUCTURE” issued to Marx and Psaltis, the entire contents of which is incorporated herein by reference, is addressed to a system and method for measuring the dimensions of a small (e.g., microelectronic) structure. The invention is an optical system and method that uses a linearly polarized light beam, reflected off or transmitted through, a structure, to measure the structural parameters, such as the lateral dimensions, vertical dimensions, height, or the type of structural material. The system employs a light source to generate a light beam that is linearly polarized and focused onto the structure to be measured. The structure is illuminated with TE and TM polarized light. The structure is dimensioned such that the TM and TE fields are affected differently by the diffraction off the structure. As a result, either the TE or TM field can be used as a reference to analyze the phase and amplitude changes in the other field. Differences between the diffracted TE and TM far fields allow a comparison of the relationship between the amplitude and phase of those fields to determine the structural parameters of a structure.

U.S. Pat. No. 6,512,733 entitled “OPTICAL RECORDING METHOD, OPTICAL RECORDING APPARATUS, OPTICAL READING METHOD, AND OPTICAL READING APPARATUS” issued to Kawano et al is addressed to a recording method in which a plurality of polarization distributions corresponding to the data information is generated and irradiated onto an optical recording medium to thereby record a plurality of polarization distributions of the recording light on the optical recording medium as photo-induced birefringence. Unfortunately, only a limited selection of materials having the appropriate photo-induced birefringence which is retained is available.

Patent Abstracts of Japan Publication Nr. 04-038720 entitled “OPTICAL MULTIVALUE RECORDING/REPRODUCING SYSTEM” based on application 02-141680 by Yutaka and Chiaki of Jun. 1, 1990, and its associated Japanese Public Patent Disclosure Bulletin No. H4-38720 published Feb. 7, 1992 describes multi-state recording executed by inclining the recording pit or groove by a prescribed angle to the track direction. A resultant diffraction beam intensity pattern is formed on two line sensors by using an optical system. The diffraction pattern rotates by an angle corresponding to the inclination of the recording pit or groove. The amount of inclination is detected by the two line sensors, which act to detect the boundary point of light and darkness of the diffraction pattern. Detection is thus accomplished by a light intensity pattern of reflected/diffracted light. Unfortunately, resolution based on light intensity is difficult and has not been commercially successful.

U.S. Pat. No. 4,681,450 entitled “PHOTODETECTOR ARRANGEMENT FOR MEASURING THE STATE OF POLARIZATION OF LIGHT” issued to Azzam, the entire contents of which is incorporated herein by reference, discloses a photopolarimeter for the simultaneous measurement of all four Stokes parameters of light.

Thus, there is a need for an improved encoding method having an improved resolution suitable for use with low cost optical storage media.

### SUMMARY OF THE INVENTION

Accordingly, it is a principal object of the present invention to overcome the disadvantages of prior art encoding methods. This is provided in the present invention by encoding data by planar orientation of marks, such as pits.

The marks are sized to be of sub-wavelength width, with a length greater than the width. The depth or height of the mark is preferably λ/4, however other depth or heights may be used without exceeding the scope of the invention. A polarized light source is used to read the mark, either by reflection or transmission. Collected light exhibits an elliptic polarization anisotropy, with the principle axis of the ellipse corresponding to the planar orientation of the mark. The collected light is detected by at least one polarization sensitive detector. The output of the detector is used to determine the direction of the axis of the polarization ellipse thereby decoding the orientation of the mark being read.

For a given incident beam of fixed polarization (e.g., circular polarization), a rotation of the mark orientation gives rise to a corresponding rotation of the reflected light polarization ellipse. Thus, the planar orientation of the mark which may be set to one of a plurality of conditions encodes data.

Additionally the polarization ellipticity corresponds with the dimensional aspect ratio of the mark. Thus, in one embodiment information is encoded in the dimensional aspect ratio of the mark orthogonally with the planar orientation.

Additionally, the total intensity of the reflected light corresponds with the mark surface area. Thus, in one embodiment information is encoded in the total mark surface area orthogonally with encoding with either or both planar orientation and the dimensional ratio.

The invention provides for an optical storage medium designed to be readable with light of a pre-determined wavelength, the optical storage medium comprising: a substrate; and a plurality of optically detectable marks imprinted on the substrate, each of the plurality of optically detectable marks exhibiting: a predetermined length; a width less than the pre-determined wavelength; and one of a plurality of orientations in relation to a common axis, wherein information is stored on the optical storage medium at least partially as a function of the one of a plurality of orientations. Preferably the optically detectably marks alter the polarization characteristics of an incident polarized light of the pre-determined wavelength, the altered polarization characteristics being detectable by at least one detector.

In one embodiment the substrate comprises a circular platter with a center spindle hole, the circular platter comprising at least one reflective layer. In one further embodiment the substrate further comprises a coating layer above the at least one reflective layer, the coating layer being substantially non-birefringent. In another further embodiment the common axis is a spiral track, the spiral track being radially centered on a center spindle hole.

In one embodiment the optically detectable marks comprise pits. In one further embodiment the predetermined length is between 2/3 and 3/2 of the predetermined wavelength and in another further preferred embodiment the predetermined length is between 550/650 and 700/650 of the pre-determined wavelength.

In one embodiment the common axis comprises a spiral track and the optically detectable marks are separated by a minimum distance between the centers of successive optically detectable marks along the same track of greater than 7/6 of the pre-determined wavelength. In another embodiment the common axis comprises a spiral track and the optically detectable marks are separated by a minimum distance between the centers of successive optically detectable marks along the same track of greater than 8/6 of the pre-determined wavelength. In another embodiment the common axis comprises a spiral track and centers of the optically detectable marks of a given track of the spiral track exhibit a distance from centers of optically detectable marks of neighboring tracks of the spiral track greater than 7/6 of the pre-determined wavelength. In yet another embodiment the common axis comprises a spiral track and centers of the optically detectable marks of a given track of the spiral track exhibit a distance from centers of optically detectable marks of neighboring tracks of the spiral track greater than 8/6 of the pre-determined wavelength.

In one embodiment the plurality of orientations are evenly distributed in relation to the common axis, the plurality of orientations further exhibiting a maximum angular deviation from the common axis. In another embodiment the width of each of the plurality of optically detectable marks is selected from a plurality of widths, and wherein information is stored on the optical storage medium at least partially as a function of the selected one of a plurality of widths.

In one embodiment the optically detectable marks exhibit a width less than 50% of the pre-determined wavelength, preferably less than 40% of the predetermined wavelength, and even further preferably less than 33% of the predetermined wavelength.

In one embodiment the marks comprise pits having a plurality of respective pit depths, wherein information is stored on the optical storage medium at least partially as a function of the selected pit depths. In another embodiment the plurality of optically detectable marks imprinted on the substrate are placed in a regular pattern of locations, a mark being placed in each of locations. In yet another embodiment the plurality of optically detectable marks imprinted on the substrate are selected such that the set of marks immediately adjacent any of the plurality of optically detectable marks are not all of the same orientation.

The invention independently provides for a method of optical recording of data to be readable with light of a pre-determined wavelength, the method comprising: providing a substrate; and imprinting on the substrate a plurality of optically detectable marks, each of the plurality of optically detectable marks exhibiting: a predetermined length; a width less than the pre-determined wavelength; and one of a plurality of orientations in relation to a common axis, information being encoded by the selection of one of a the plurality of orientations.

The invention independently provides for a method of optical recording of data to be readable with light of a pre-determined wavelength, the method comprising: providing a substrate; and imprinting on the substrate a plurality of optically detectable marks, each of the plurality of optically detectable marks exhibiting: a predetermined length; one of a plurality of widths, each of the plurality of width being less than the pre-determined wavelength; and one of a plurality of orientations in relation to a common axis, wherein information is encoded by a selection of one of a the plurality of orientations in combination with one of the plurality of widths.

The invention independently provides for an optical information reading apparatus comprising: an optical storage medium comprising a plurality of optically detectable marks having data encoded at least partially as a function of the orientation of each of the optically detectable marks, the marks exhibiting a single pre-determined length and a width less than a pre-determined wavelength; a polarized light source outputting light of the pre-determined wavelength; a means for focusing the output light on one of the plurality of optically detectable marks; and a means for detecting an orientation of a polarization ellipse as a consequence of the focused light of the pre-determined wavelength having interacted with the mark of the optical storage medium.

In one embodiment the means for detection an orientation comprises at least three polarization detectors each detecting the polarization in a different orientation from the others. In one further embodiment the means for detection of an orientation comprises an orientation determiner in communication with the at least three polarization detectors, the apparatus further comprising: an intensity determiner in communication with the at least three polarization detectors; and an ellipticity determiner in communication with the at least three polarization detectors, the orientation determiner being operable to detect the orientation of each one of the plurality of optically detectable marks as a function of the at least three polarization detectors, the intensity determiner being operable to detect the width of each of the plurality of optically detectable marks as a function of the at least three polarization detectors, and the ellipticity determiner being operable to detect an aspect ratio of each of the plurality of optically detectable marks as a function of the at least three polarization detectors. In another further embodiment the orientation of the mark is determined from the output of the at least three polarization detectors.

The invention independently provides for an optical storage reader for use with an optical storage medium comprising a plurality of optically detectable marks having data encoded at least partially as a function of the orientation of each of the optically detectable marks, each of the optically detectable marks having a width smaller than a pre-determined wavelength, the optical storage reader comprising: a polarized light source emitting light of the pre-determined wavelength, the polarized light source optically impacting each of the plurality of optically detectable marks of the optical storage medium thereby generating a polarization ellipse having an axis associated with the orientation of each of the optically detectable marks; and at least one polarized detector, the at least one polarized detector detecting the orientation of the polarization ellipse thereby optically reading the encoded data of each of the optically detectable marks.

In one embodiment the polarized light source comprises one of a linear polarized light source and a circular polarized light source. In another embodiment the polarized light source is a linear polarized light source, and the at least one polarized detector is a linear polarized detector. In a further embodiment the at least one polarized detector is aligned to exhibit polarization at 90° to the linear polarization of the linear polarized light source.

In one embodiment the optical storage reader further comprises a splitter the splitter receiving the polarization ellipse, the at least one polarized detector comprising a plurality of linear polarized detectors in optical communication with the splitter. In one further embodiment the plurality of linear polarized detectors comprise two linear polarized detectors having linear polarizations oriented at 90° to each other.

In one embodiment the at least one polarized detector comprises a plurality of pairs of polarized detectors, each of the pairs being associated with a unique one of the orientations of the polarization ellipse. In a further embodiment the pairs of polarized detectors comprise two linear polarized detectors having linear polarizations oriented at 90° to each other.

In one embodiment the at least one polarized detector comprises at least three linear polarized detectors. In one further embodiment the at least three linear polarized detectors are arranged to detect the Stokes parameters of the polarization ellipse.

In one embodiment the at least one polarized detector comprises at least 4 linear polarized detectors arranged to characterize the polarization ellipse. In one further embodiment the characterization of the polarization ellipse includes utilizing the Stokes parameters.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a view of a substrate comprising a plurality of marks exhibiting orientation based encoding according to the principle of the invention;

FIG. 2a illustrates a top view of a mark illustrating various possible orientations;

FIG. 2b illustrates an example of elliptical anisotropy created by reflection from the varying sub-wavelength pit orientation 20 of FIG. 2a;

FIG. 3 illustrates a 3 dimensional view of a pit embodiment of a mark according to the principle of the invention;

FIG. 4 illustrates a right-handed orthogonal coordinate system with an ellipse whose major axis is at an angle γ to a coordinate \hat{l};

FIG. 5 illustrates a set of mark orientations distributed such that no mark is oriented along the track direction;

FIG. 6 illustrates a high level diagram of an optical reader system wherein a light beam is incident at an oblique angle to the disc surface, the reflected beam being collected at an oblique angel to the disc surface;

FIG. 7 illustrates a high level diagram of an optical memory system according to an embodiment of the principle of the invention comprising a circularly polarized light source, and four polarized detectors operable to detect characteristics of the polarization ellipse enabling calculation of the Stokes parameters with improved sensitivity;

FIG. 8 illustrates a range of principle axis orientations resulting from interference due to marks in the immediate vicinity of the mark being currently detected;

FIG. 9a illustrates a high level diagram of an optical memory system according to an embodiment of the principle of the invention comprising a linear polarized light source and a linear polarized detector in accordance with the principle of the invention;

FIG. 9b illustrates a high level diagram of an optical memory system according to an embodiment of the principle of the invention utilizing a linearly polarized light and two detectors each detecting orthogonal linear polarizations of the output of the beam splitter;

FIG. 10a illustrates a high level diagram of an optical memory system according to an embodiment of the principle of the invention comprising a light source, a circular polarizer and a pair of linear polarized detectors;

FIG. 10b illustrates a high level diagram of an optical memory system 950 according to an embodiment of the principle of the invention utilizing circularly polarized light and a single linear polarized detector; and

FIG. 10c illustrates a high level diagram of an optical memory system according to an embodiment of the principle of the invention comprising a circularly polarized light source and an array of orthogonally polarized pairs of detectors, each pair being associated with a particular one of each of the possible orientations of the optically detectable mark.

### DETAILED DESCRIPTION OF THE PREFERRED EMBODIMENTS

The present embodiments enable encoding data in an optical memory by planar orientation of marks, such as pits or bumps. The marks are sized to be of sub-wavelength width, with a length comparable to, or larger than, the wavelength. The operative wavelength is hereinafter denoted by λ. The depth or height of the mark is preferably λ/4, however other depth or heights may be used without exceeding the scope of the invention. A polarized light source is used to read the mark, typically by one of reflection and transmission. Collected light exhibits an elliptic anisotropy, with the principle axis of the ellipse corresponding to the planar orientation of the mark. The collected light is detected by a plurality of polarization sensitive detectors, the intensity and polarization pattern of the collected light indicating the direction of the axis of the ellipse. Thus, the varying planar orientation of the mark encodes the data.

The specific relationship between the pit mark orientation and the elliptic polarization orientation of the reflected light may depend upon various parameters such as the pit depth and the material composition of the optical substrate, however in practice for a given optical memory unit, such a specific disc, may be taken as fixed.

In one embodiment a linear polarized light source is used. In another embodiment a circular polarized light source is used. A plurality of methods is described enabling detection of the axis of the ellipse, thereby enabling detection of the orientation of the marks. Additionally, a plurality of mark aspect ratios may be used to increase the density of information storage.

Marks are typically embodied in pits which are formed in close proximity to one another. Consequently, a beam of light focusing on a specific pit also results in residual illumination of neighboring pits, the reflection from which results in interference with the reflection of the specific pit of interest. The ability to thus properly decode the orientation of the specific pit of interest from the measured light polarization is limited in resolution due to such interference reflection from neighboring pits. It is a further object of the current invention to reduce the range of such shifts of orientation thereby enhancing the angular resolution of detection and determination of the orientation of the specific pit of interest.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

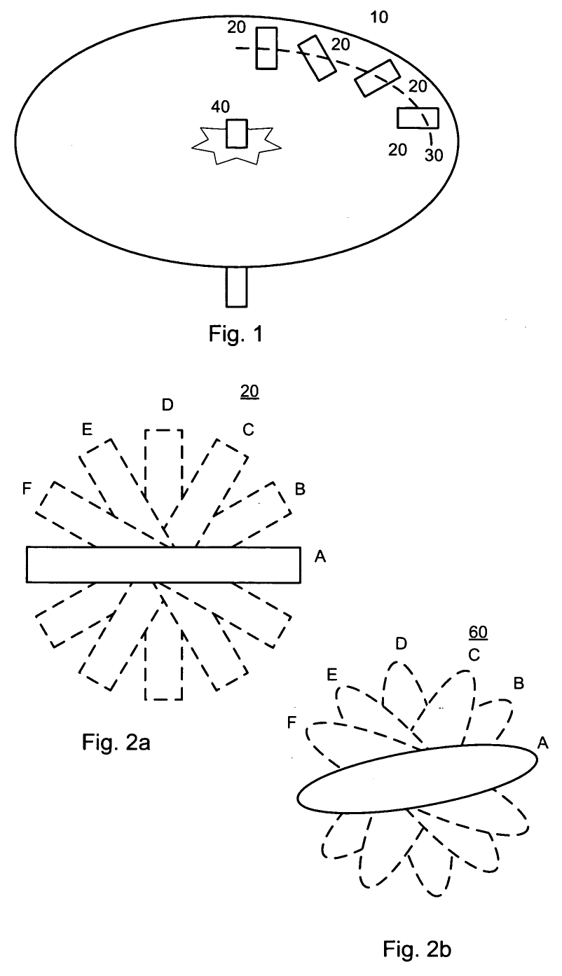

FIG. 1 illustrates a high level view of an optical recording medium according to the principle of the invention. The optical recording medium comprises substrate 10 having imprinted thereon a plurality of marks 20, each of the plurality of marks 20 having a sub-wavelength aperture and exhibiting orientation based encoding in relation to a spiral track 30, and a center spindle 40 according to the principle of the invention. Spiral track 30 defines a reference point in relation to center spindle 40 for placement and orientation of marks 20. Placement of marks 20 along a path defined by spiral track 30 allows for ease of reading, since the location of marks 20 is well defined. Various orientations of marks 20 are shown, with data being encoded at least partially by the orientation of marks 20 in relation to spiral track 30.

The optical recording medium of FIG. 1 has been illustrated with a single layer however this is not meant to be limiting in any way. The use of multiple layers is specifically included without exceeding the scope of the invention. Preferably isotropic protective layer is further placed over substrate 10 covering the plurality of marks 20. Isotropic covering layer is preferred so as to neutrally impact the polarization orientation of light impacting marks 20 as will be explained further hereinto below. Preferably, any birefringence of substrate 10 is minimized so as to minimize any impact on the polarization orientation. In an exemplary embodiment the surface of the plurality of marks 20 is covered by a reflective layer and in one further embodiment additional layers are deposited on the substrate to enhance and/or control reflectivity.

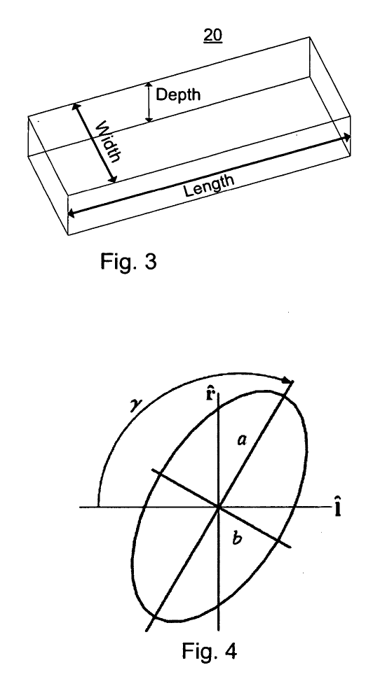

FIG. 2a illustrates a top view of a mark 20 illustrating six possible orientations, labeled A-F, respectively. Six orientations are shown for clarity, however this is not meant to be limiting in any way. Eight or more orientations are specifically included, with the limiting factor being the ability to optically discern the orientation. The invention provides for optically discerning the orientation utilizing polarized light in a manner that will be explained further hereinto below. As described further below, mark 20 comprises a sub-wavelength aperture.

Polarized light transmitted through, or reflected from, a sub-wavelength pit or aperture, in which the width is less than the wavelength of the light and the length is longer than the width exhibits an elliptical shape. The effect is such that light polarized along the axis parallel to the length of the sub-wavelength aperture sees an aperture of a size less than a wavelength. Light polarized along the axis parallel to the width of the sub-wavelength aperture sees a larger aperture and penetrates to a greater extent than the light polarized parallel to the length of the aperture. It is to be understood that mark 20 may be embodied in either a pit or a bump, and the term pit is used interchangeably herein with the term aperture. The invention is being described in an embodiment in which the mark is a pit, however this is not meant to be limiting in any way, and the invention may be practiced in an embodiment comprising optically detectable marks without exceeding the scope of the invention.

Mathematically, we define the polarization component parallel to the length of the aperture as E_{y}, and the polarization component parallel to the width as Eₓ. In an exemplary embodiment the E_{y} component is reflected to a degree similar to the reflection that would occur in the absence of the aperture. The Eₓ component penetrates the aperture to a significantly greater extent than the E_{y} component and is thus affected by the depth of the aperture to a significantly greater extent than that of the E_{y} component. In the case of reflection from the bottom of the aperture, the reflected Eₓ component experiences a phase shift equal to twice the apparent depth. Assuming equal Eₓ and E_{y} intensities on the aperture, the reflected Eₓ and E_{y} interference patterns will therefore be different.

As a consequence of the above, polarized light transmitted through, or reflected from, a sub-wavelength aperture having a width of less than the wavelength and a length larger than the width collected at an objective will have a certain elliptic anisotropy. The orientation of the principle axis of the ellipse is a function of the orientation of the axis of the aperture.

For clarity, the invention will now be further described in the case where mark 20 comprises a sub-wavelength aperture formed by a pit in a substrate, with light entering the pit impacting on a reflective layer. This is not meant to be limiting in any way, and the invention is equally applicable to raised marks of sub-wavelength aperture, or where the light is collected only after passing through the sub-wavelength aperture.

With a sub-wavelength pit 20 of some fixed physical dimensions, different planar orientations of the sub-wavelength pit 20 will manifest themselves in different orientations of the principle axis of elliptical anisotropy of the reflected light. A circularly polarized light is reflected with some elliptic polarization anisotropy where the principle axis of the ellipse is in correspondence with the orientation of elongated sub-wavelength pit 20. Thus, a one to one relationship between the orientation of the principle axis of the reflected light and the orientation of the principle axis of sub-wavelength pit 20 enables detection and ultimate decoding of orientation of sub-wavelength pit 20.

The effect is similar when using a linearly polarized light source, however that the correspondence between the orientation of the polarization ellipse and the illuminated pit mark is not a uniform angular difference. In such a case the correspondence varies with the pit orientation. Nonetheless there exits a one to one relationship between the orientation of the principle axis of the reflected light and the orientation of the principle axis of sub-wavelength pit 20 which thus enables detection and ultimate decoding of orientation of sub-wavelength pit 20. Hence, the principles of determination of the pit orientation are very much the same. The invention is herein described in relation to a circularly polarized incident beam, however this is not meant to be limiting in any way.

FIG. 2b illustrates an example of elliptical anisotropy created by reflection from the varying sub-wavelength pit orientation 20 of FIG. 2a as ellipses 60. The possible orientations of polarization ellipses 60 are labeled A-F corresponding to the orientation of sub-wavelength pits 20 of FIG. 2a. It is to be noted that orientations A-F of ellipses 60 correspond to orientations A-F of sub-wavelength pit 20, however they are not necessarily aligned.

The specific relationship between the orientation of the polarization ellipse and the orientation of the pit axis is dependent upon the depth of the pit and the material composition and layer thicknesses of the disc structure. For a given disc structure and a given pit depth, rotation of the orientation of a pit by a specific angle will result in a similar angle of rotation of the reflected light polarization ellipse.

In a typical application, such as an embodiment of an optical memory on a disc, pits on the surface are formed in close proximity to one another. Consequently, a beam of light focusing on a specific pit also results in residual illumination of neighboring pits, the reflection from which results in interference with the reflection of the specific pit of interest. Residual illumination from neighboring pits results in interference resulting in an effective shift in the angle of rotation of the detected polarization ellipse. Thus the ability to decode the orientation of the pit of interest from the measured light polarization is limited in resolution due to interference reflection from neighboring pits. It is to be noted that interference may affect the collected light intensity and the eccentricity of the detected ellipse in addition to the above mentioned rotational effect.

FIG. 3 illustrates a 3 dimensional view of a sub-wavelength pit embodiment of mark 20 according to the principle of the invention. Sub-wavelength pit 20 exhibits a width less than the operative optical wavelength, λ, and a length greater than the width. In a preferred embodiment the width of sub-wavelength pit 20 is less than 80% of λ. In one further preferred embodiment the width of sub-wavelength pit 20 is less than or equal to 50% of λ. In another further preferred embodiment the width of sub-wavelength pit 20 is less than or equal to 40% of λ. In yet another further preferred embodiment the width of sub-wavelength pit 20 is less than or equal to 33% of λ.

In an exemplary embodiment, the length of sub-wavelength pit 20 is on the order of λ. Preferably, the length is larger than the width by a sufficient amount to induce a detectable elliptic anisotropy of ellipse 60.

The depth of sub-wavelength pit 20 affects the phase shift of the polarized light component that penetrates sub-wavelength pit 20. In an exemplary embodiment the depth is λ/4, thus leading to a phase shift of λ/2 for light reflected from the bottom of sub-wavelength pit 20. A phase shift of λ/2 results in destructive cancellation of the reflected light.

The principle behind detection of the principle axis of polarization ellipse 60 of FIG. 2b will now be described. Fundamentally, different reflection coefficients parallel and perpendicular to the pit give rise to a polarization rotation of the reflected light, and change an incident circular polarization to a reflected elliptic polarization. Prior art devices, such as DVD players, work with a circular polarized light source, and the present invention shows significant advantages over prior art systems when used with such a circular polarized light source. On the other hand, use of a linear polarized light source is simple to implement, and in certain embodiment may result in improved resolution as compared with the use of a circular polarized light source.

In particular, the reflected total intensity from a circular polarized light source is independent of the reflected polarization characteristics. Therefore, these two degrees of freedom can be exploited independently. In particular, we can design the pits to have N states, by combining M intensity levels (determined for example by pit depth or pit surface area) and P polarization states (determined by pit orientation and/or pit shape aspect ratio), so that N=M*P. In a further embodiment described hereinto below, for each specific intensity level there is a defined a particular number of polarization states.

It is to be noted that the angular resolution of pit orientations is at least partially determined by the angular spread of reflected elliptic polarization orientation with all possible states of neighboring pits. To uniquely identify a particular angular orientation of a specific pit of interest, the associated spread of reflected polarization orientation should preferably be non-overlapping with the spread of any other possible pit orientation.

Similarly, there is a limit of the intensity resolution due to reflection from neighboring pits.

A complete description and detection of elliptic polarization can be accomplished using Stokes parameters. A detailed analysis and background can be found in F. Couchot et al., “Optimized Plarimeter Configurations for Measuring the Stokes Parameters of the Cosmic Microwave Background Radiation”, Astron. Astrophys. Suppl. Ser. Vol 135 p. 579 (1999) published by the European Southern Observatory, whose entire contents are incorporated herein by reference.

A complete description and detection of elliptic polarization is desired. Let \hat{r} and \hat{l} form a right-handed orthogonal coordinate system with the propagation direction s as shown in FIG. 4. The semi-major axes of the ellipse are denoted “a” and “b”, and γ is the angle between \hat{l} and major axis “a” of the ellipse. γ is the parameter of interest which defines “the orientation of the polarization ellipse”. The ellipse, which is in all respects similar to ellipse 60 of FIG. 2b is defined by three free parameters called Stokes parameters.

| | | |
|---|---|---|
| I = Iᵣ + Iₗ | is the total intensity. | Equation (1) |
| Q = Iᵣ − Iₗ | indicates the degree of polarization | Equation (2) |
| U = Q tan(2γ) | | Equation (3) |

where we use the notation Iₓ to denote the measured light intensity with polarization x. It is also common to define the elliptic eccentricity as a/b.

The three stokes parameters can be determined from a measurement of at least 3 polarization measurements. An over specification by a larger number of detectors may be used to reduce the measurement error. The intensity detected by a polarimeter rotated by an angle γ as shown in FIG. 4 is given by:
I_{γ}=½*(I+Q cos 2γ+U sin 2γ) Equation (4)
Since there are three parameters, preferably a minimum of 3 detectors at different angles is utilized. Error is minimized when the detectors angles are evenly distributed over 180 degrees.

We shall explicitly present an analysis of an exemplary embodiment comprising 4 detectors. These should be understood by way of example, and do not exclude the application of a larger number of detectors or of detectors whose angular polarization orientation is not evenly distributed.

In the case of 4 detectors at polarization angles 0, 45, 90, 135 degrees, the Stokes parameters are found from the detector intensity measurements according to the following formulas:
I=I₀+I₉₀,
Q=I₀−I₉₀,
U=I₄₅−I₁₃₅. Equation (5)

The total intensity “I” is determined by the light source intensity and the shape and size of pit 20. Given the detected value U, then properly inverting equation 3 gives the value of the angle γ which determines the associated pit orientation. Furthermore, the eccentricity can be determined by

$$\frac{b}{a} = \sqrt{\frac{I - \sqrt{{Q}^{2} + {U}^{2}}}{I + \sqrt{{Q}^{2} + {U}^{2}}}} \qquad Equation ( 6 )$$

Therefore, the reflected light caries detectable information in the light intensity, the elliptic polarization orientation and the polarization ellipticity. These can be affected by the pit geometry in the following way: The reflected polarization orientation is in correspondence with the pit orientation. The reflected polarization eccentricity is correspondence with the pit dimensional aspect ratio. The pit surface area is in correspondence with the total reflected light intensity. Hence, combinations of these pit parameters can serve to encode information.

The polarization characteristics of the light reflected from a pit mark is not uniform in space. A detector effectively performs some average over its viewing window. Similarly, the set of detectors used for determining the Stokes parameters detects information which is used to obtain an average value of the Stokes parameters over the specific viewing window of the detectors. Thus, the obtained Stokes parameters vary depending on the position and viewing window of reflected light collected by the set of detectors. Preferably a mask or aperture, as will be described further hereinto below, limiting the angle of detection is utilized to improve discrimination of the Stokes parameters. It is further to be understood that there is no requirement to identify the Stokes parameters. In one embodiment an artificial neural network computation system in combination with the output of the various detectors identifies the pit orientation.

The stability and resolution of pit orientation is affected by an optimal choice of the detectors viewing window. FIG. 6 illustrates a high level block diagram of an optical reader system 600 comprising a light source 310, optical system 620, optical memory 625, angular window mask 630 and detector 640. The circularly polarized incident light beam originating from light source 310 is focused on a particular pit mark by an optical system 620, arrives at an angle φ to optical memory 625 on which the pits are situated. In an exemplary embodiment optical memory 625 comprises substrate 10 and pits 20 of FIG. 1. The incident light is reflected in all directions, at different polarization states. The dependence of reflected polarization as a function of observation angle θ varies most slowly when the observation angle θ=φ. Therefore, it is preferable that observation angle θ of detectors 640 be equal to the incident light angle φ. Angular window mask 630 thus functions to improve polarization detection while sacrificing intensity.

In prior art applications such as DVD discs, there are two distinct cases for beam propagation to and from the disc surface:
(a) Light beam is incident perpendicular to the surface, and commonly also reflected light is collected at an angle perpendicular to the surface. This is the method commonly used for reading from DVD-ROM discs
(b) Light beam is incident at a non-perpendicular angle to the disc, and commonly also the reflected light is collected an angle not perpendicular to the disc.

As described above, in a preferred embodiment of the present invention, and in particular when embodied in a optical memory disc, it is preferable to use a light beam incident at an obtuse angle to the disc, and further preferably to collect the reflected light at an obtuse angle.

The use of such illumination has two benefits. First, light incident at an angle to the surface illuminating pits other than the pit of interest at a slightly different phase. Consequently, the coherent interference from the pits other than the pit of interest is reduced, leading to improved resolution in identifying the pit of interest on which the beam is focused. Second, the light arriving at an angle to the disc is naturally reflected away thus reducing back reflection to light source.

Moreover, to minimize the variation of polarization states within the detector's window, it is preferable than angular window mask 630 be implemented as a circular mask 630 to limit the angular window of collected light to a specific range of angles. The choice of angular window should be such that slight misalignments will not be a source of significant variation in the measured Stokes parameters. Also, a compromise needs to be made due to the fact that the bigger the angular window, the bigger is the total intensity of collected light. In a preferred embodiment angular windows allowing light of 5-30 degrees from the center axis in which θ=φ are utilized.

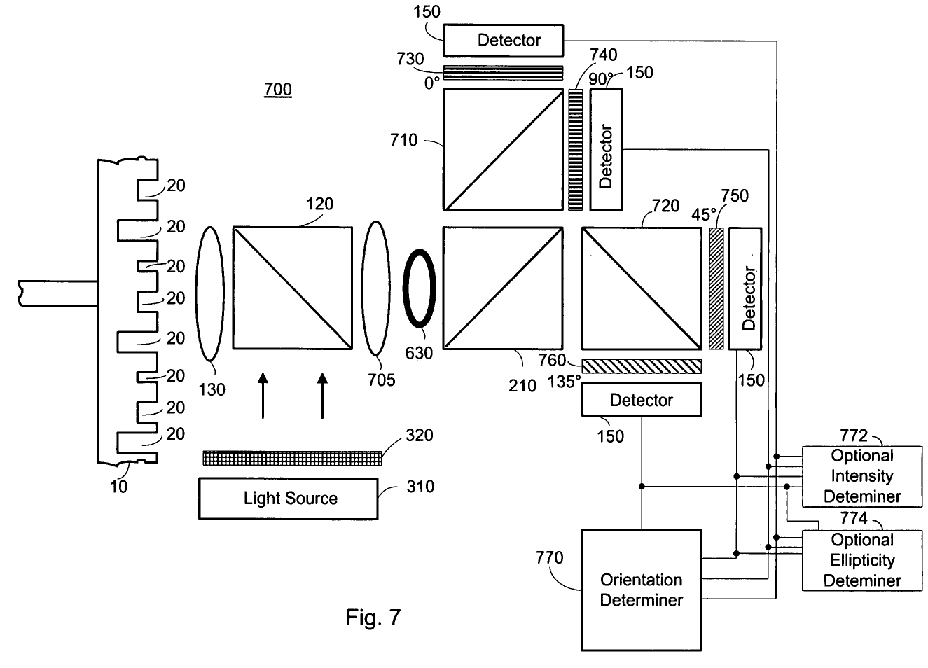

FIG. 7 illustrates a high level diagram of an optical memory system 700 according to an embodiment of the principle of the invention, comprising a light source 310, circular polarizer 320, and four detectors 150 each having an associated linear polarizers 730, 740, 750 and 760 respectively, the combination of detectors 150 and respective polarization filters being operable to detect characteristics of the polarization ellipse thereby enabling calculation of the Stokes parameters. In particular, optical memory system 700 further comprises first beam splitter 120; lens 130; substrate 10 comprising a plurality of pits 20; optional collimating lens 705, optional angular window mask 630, second beam splitter 210; third beam splitter 710; fourth beam splitter 720; first linear polarizer 730; second linear polarizer 740; third linear polarizer 750; fourth linear polarizer 760; first, second, third and fourth detectors 150; orientation determiner 770; optional intensity determiner 772; and optional ellipticity determiner 774. In an exemplary embodiment light source 310 comprises a laser diode.

First beam splitter 120 and lens 130 are arranged to channel circularly polarized light from light source 310 to illuminate pits 20 of substrate 10. In one embodiment, first beam splitter 120 and lens 130 are further arranged to channel light reflected from pits 20 of substrate 10 to be incident on second beam splitter 210 via optional collimating lens 705 and angular window mask 630. In an alternative embodiment, as depicted in relation to FIG. 6 the reflected optical path need not pass through the same first beam splitter 120 as the incident beam. A first split output of second beam splitter 210 is incident on third beam splitter 710. A first split output of third beam splitter 710 is incident on first detector 150 through first linear polarizer 730. A second split output of third beam splitter 710 is incident on second detector 150 through second linear polarizer 740. In an exemplary embodiment first and second linear polarizers 730, 740 are orthogonal to each other, preferably at 0° and 90° respectively to an axis.

A second split output of second beam splitter 210 is incident on fourth beam splitter 720. A first split output of fourth beam splitter 720 is incident on third detector 150 through third linear polarizer 750. A second split output of fourth beam splitter 720 is incident on fourth detector 150 through fourth linear polarizer 760. In an exemplary embodiment third and fourth linear polarizer are orthogonal to each other, and preferably rotated 45° with respect to first and second linear polarizers 730, 740. A total of 4 linear polarized detectors are therefore provided preferably at 0°, 45°, 90° and 135° with the polarization angles being expressed respective to the axis of detection. Orientation determiner 770 is connected to the output of each of first through fourth detectors 150. Optional intensity determiner 772 and optional ellipticity determiner 774 are arrange to receive the output of each of first through fourth detectors 150

In operation, light source 310 emits light which is circularly polarized by circular polarizer 320 and then channeled by first beam splitter 120 and lens 130 to illuminate substrate 10 having a plurality of pits 20 imprinted thereon. The reflection, having encoded thereon the orientation of each of pits 20, optionally the pit depths, and further optionally the pit aspect ratio, is channeled, optionally collimated by optional collimating lens 705 and optionally angularly restricted by optional angular window mask 630 to second beam splitter 210. The light is then further channeled to third beam splitter 710 and fourth beam splitter 720 to first, second, third and fourth detectors 150 through respective first, second, third and fourth linear polarizer 730, 740, 750 and 760. As described above, in an exemplary embodiment first, second, third and fourth linear polarizers 730, 740, 750 and 760 are polarized at respective 0°, 45°, 90° and 135° with respect to the axis of detection. Orientation determiner 770 preferably utilizes Equations 1-6, to calculate the orientation encoding of pits 20 as a function of the output of first, second, third and fourth detectors 150. Orientation determiner 770 may be embodied in a software program in a general purpose computing platform, in a microcontroller, an ASIC or a neural network without exceeding the scope of the invention.

Optional intensity determiner 722 is operable to detect the width of each of the optically detectable marks as a function of the detectors. Optional ellipticity determiner 724 is operable to detect an aspect ratio of each of the optically detectable marks as a function of the detectors.

Furthermore, the use of a plurality of detectors enables the decoding of each of the orientation of polarization ellipse 60, the total light intensity and polarization ellipticity. Thus pit aspect ratio, surface area and orientation encoding may be combined in a single pit mark 20.

Pits 20 are not limited to be of uniform depth, shape, or size, as optical memory system 700 enables intensity, orientation, and ellipticity methods of encoding information to be used in combination in a single pit mark 20.

Optical memory system 700 has been illustrated with four separate beam splitters, however this is not meant to be limiting in any way. A single array of linear polarized detectors may be substituted without exceeding the scope of the invention. Optical memory system 700 has been described as utilizing reflected light incident directly onto substrate 10 however this is not meant to be limiting in any way. Optical memory system 700 may be designed to use transmitted light or to use reflected light at an angle as described above in relation to FIG. 6 without exceeding the scope of the invention.

The optical path to the detectors in system 700 has been illustrated with a serial combination of beam splitters {710,720} and polarizing elements {730,740,750,760}. However this is not meant to be limiting in any way. For example certain optical elements, such as Nicol prisms, Glan-Thompson prisms and Wollaston prisms simultaneously split the beam into orthogonal polarization components. In one embodiment the combination of beam splitter 710 and polarizing elements 730, 740 as well as the combination of beam splitter 720 and polarizing elements 750, 760 comprises one of a Nicol prism, a Glan-Thompson prism and a Wollaston prism. Preferably a Wollaston prism is utilized for both combinations, however this is not meant to be limiting in any way. In one embodiment the use of a combination element as described above may further require the use of a light spreading element such as an offset prism. Additionally combination elements often exhibit greater attenuation in one of the polarization paths as compared with the second polarization path. Compensation is preferably provided either through amplification of the greater attenuated path, or more preferably in the calculation of the polarization orientation based on the output of the detectors 150, for example by use of an arithmetic multiplication factor.

In another embodiment, as described in the above mentioned U.S. Pat. No. 4,681,450 to Azzam, a photopolarimeter comprising four detectors is utilized. Such an embodiment does not require the use of beam splitters. The light beam is arranged to strike, at oblique angles of incidence, three photodetector surfaces in succession, each of which is partially specularly reflecting and each of which generates an electrical signal proportional to the fraction of the radiation it absorbs. A fourth photodetector is substantially totally light absorbative and detects the remainder of the light. The four outputs thus develop form a 4×1 signal vector which is linearly related to the input Stokes vector. Advantageously, this method enables the simultaneous obtaining of the four Stokes parameters in one simple matrix multiplication operation. Moreover, since no beam splitters are involved in the distribution of light between the four detectors, this embodiment has the potential of reduced cost and ease of mass production.

In spite of the above noted advantages of using a light beam incident at a non-perpendicular angle to substrate 10, due to size constraints in certain applications it may be preferable to use a design exhibiting a light beam incident at a perpendicular angle to substrate 10. Furthermore light may be illuminated from the rear of substrate 10 with detectors 150 inputting transmitted light without exceeding the scope of the invention.

In the above referenced U.S. Pat. No. 5,144,615, and elsewhere in the literature, emphasize was made on affecting the total detected light intensity by varying the pit depth. Varying the pit depth however has a significant effect on the polarization orientation. It is a novel aspect of the invention that in one embodiment varying the pit surface area, preferably by varying the pit width while maintaining the pit length, has an effect of modifying the reflected light intensity without significantly impacting the polarization orientation. Hence, in a preferred embodiment the pits have uniform depth, while multi-levels of reflected intensity are produced by varying the pit surface area.

Advantageously, maintaining a uniform pit depth reduces manufacturing cost, since manufacturing of several different pit depths, or of gradually sloping surface walls, on a given surface, is more expensive and slower than manufacturing pits of uniform depth.

As described above, in one embodiment information is further encoded by the polarization eccentricity. The eccentricity of reflected light is primarily affected by the aspect ratio of the pit surface. i.e., pits of width much less then the length give rise to light reflected with higher eccentricity then pits of width nearly equal to their length.

In a preferred embodiment, one set of pits will have high surface aspect ratio, in which the aspect ratio is defined by the length/width, and be identified by reflected light exhibiting a high degree of eccentricity, while another set of pits will have an aspect ratio closer to 1 and be identified by reflected light exhibiting a lower degree of eccentricity.

It is to be noted that each of these set of pits can have members within it differing in resulting reflected intensity, by modifying the total surface area. For example, pits exhibiting a low aspect ratio and different surface areas will all give rise to light reflected with low eccentricity, but with different total intensity.

In a preferred embodiment, the multi-levels of reflected intensity are produced from elongated pits by keeping the pit length fixed while varying the pit width thus varying the pit surface area is varied.

Determination of Pit Orientation Resolution and the Limitation of Such Resolution in Practical Situations

When a single pit of given shape and dimensions on a surface is illuminated with a focused beam of circularly polarized light, there is a resulting unique elliptical polarization state of the reflected light in a specific viewing angle.

In particular, the elliptic polarization principle axis has a specific angle δ with respect to the orientation of the long axis of the pit. Thus, rotating the pit by amount ρ results in a corresponding rotation of the polarization ellipse by the same amount ρ when viewed at the same viewing angle.

Real detectors are of finite size. Hence the elliptical polarization orientation inferred from the Stokes parameters, as measured by real detectors, is in fact some average over a range of viewing angles. Yet, this average is also of fixed value for given detector with fixed predetermined angular window. Therefore, the detected polarization orientation exhibits a specific angle <δ> with respect to the orientation of the long axis of the pit. Thus, rotating the pit by amount ρ results in a corresponding rotation of the detected polarization ellipse by the same amount ρ at the same detector viewing window.

Hence, in an ideal measurement of a single pit on a surface, there would be a one-to-one correspondence between the detected polarization orientation <γ> and the actual pit orientation. The pit orientation can then be determined or resolved with high angular accuracy from the output of the detectors. A very large number of single pit orientations would in principle be able to encode a large amount of information.

Yet, in situations applicable to commercial applications, such as an optical disc rotating at high speed and having a high information density, the one-to-one correspondence between pit orientation and polarization orientation is not maintained, and is a source of degradation of the angular resolution as will be describer further hereinto below.

In commercial applications, such as those exemplified by DVD discs of the prior art, the pits are very close to one another. In order to maximize information storage capability, similar pit placement density is tolerated in an embodiment of the invention. Consequently, the light beam focused on a given pit exhibits residual illumination of the neighboring pits. We shall refer to the pit at the focus of the incident light beam as “the central pit” and to the neighboring pits as “environment pits”.

The light reflected from the environment pits may have a different polarization than the light reflected from the central pit. Consequently, the interference of the light reflected from the environment pits interferes with the light reflected from the central pit resulting in a deviation of the measured polarization orientation and intensity at the detectors.

Therefore, instead of the ideal one polarization state per pit, there is a range of polarization states which are associated with the reflection of circular polarized light from a central pit, depending on the identity and arrangement of the environment pits. In order to be able to uniquely identify the orientation of the central pit from the detected polarization, the set of possible pits is preferably chosen such that there will be no overlap between the full range of possible polarization states reflected from the central pit with all possible environment pits. This is a preferred resolution condition.

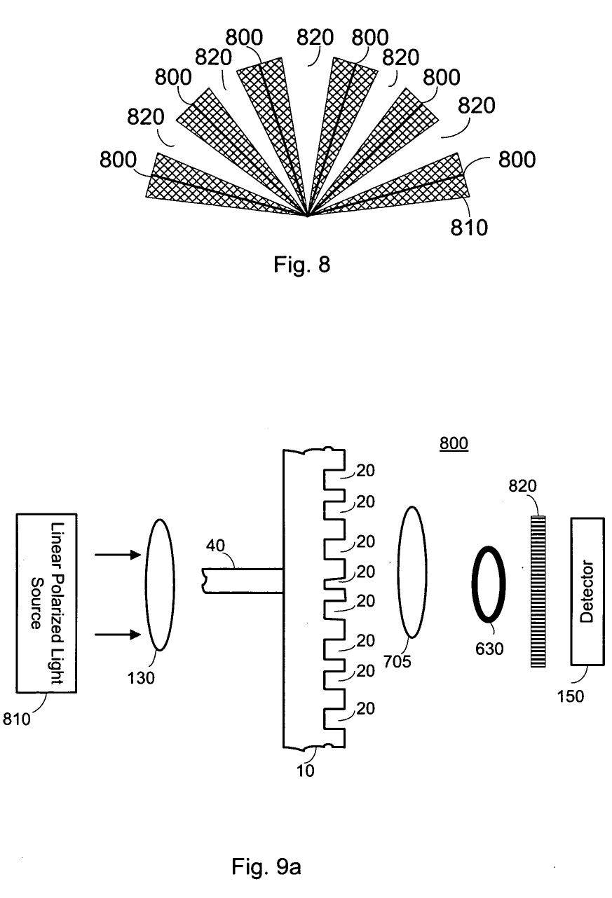

FIG. 8 illustrates a set of polarization states which satisfies the above condition. Polarization states A-F are depicted, with each polarization state being depicted by a central nominal line 800 and a range of detected polarization states depicted by a cross hatch area 810. Area 810 depicts the domain of polarization orientations associated with illuminating a central pit in all possible situations of environment pits. Central line 800 of each of polarization states A-F corresponds with a pit orientation. Thus, 6 separate single valued polarization orientations are depicted with no overlap between the associated detected polarization states.

As explained above, interference from environment pits is dependent on the distance of the pits from one another, with the distance being defined as the distance between the centers of two adjacent pits. Preferably the minimum separation between centers of marks or pits of a given track and centers of marks of its nearest neighboring tracks are greater than 7/6 of the mark or pit length. Even further preferably the minimum separation is greater than 8/6 of the mark or pit length. Preferably the minimum separation between centers of marks or pits of a given track and centers of marks of its nearest neighboring mark or pit on the same track are greater than 7/6 of the mark or pit length. Even further preferably the minimum separation between centers of marks or pits on the same track is greater than 8/6 of the mark or pit length.

In one embodiment a pit length of 55/65 of the operative wavelength is preferred and the distance between pits both along a same track and between adjacent tracks is 750/650 of the operative wavelength.

In addition to the presence of various environment pits, in practical applications there are other sources of deviation of the measured polarization state from the ideal situation. One such source of deviation is the possibility that the illuminating beam is not focused exactly on the center of the pit. Another source is imperfections in the pit structure. The resulting deviations from such imperfections are typically small compared to the deviations resulting from the variety of environment pits. Preferably a guard band illustrated by white area 820 is left between potential polarization states to resolve such imperfections.

Thus, a set of pits to be used for encoding is to be selected such that there will be no overlap of the domains of associated reflected polarization states after accounting for all sources of deviation.

Method of Increasing the Intensity Level Resolution by Excluding “No-Pit” States from the Set of Possible Pit Marks

As discussed above the interference of reflection from neighboring pits inhibits the resolution of intensity levels of the central pit of interest. The largest interference to the detected polarization state of the central pit is caused by environment pits exhibiting no indent on the surface. In particular, pit locations represent a regular pattern, and intensity levels contributed by “no-pit” states, i.e., intended pit locations in which no physical pit mark was indented on the surface. The system is preferably improved by encoding data while not allowing for locations in which no-pit has been indented. Hence, in a preferred embodiment, the set of pits used to encode data will not include a “no-pit” location.

Consequently, the reduced variation in the environment range of intensity levels leads to an improved resolution of the pit characteristics of the central pit, and in particular the reflected light intensity. As described above, changes in the reflected light intensity may reflect encoding either by pit depth variation and/or pit surface area variation.

Additionally, in the event that all environment pits directly adjacent to the central pit exhibit an identical rotation of close to 45° to the orientation of the central pit, a maximum deviation of the detected polarization ellipse occurs. Thus, in one embodiment coding is restricted to prevent such an occurrence.

Method of Disc Formatting with Dynamic Calibration of States

Various manufacturing characteristics, which may be specific to a given disc manufactured by a specific machine, affect the relationship between the pit orientation on the disc surface and the resulting elliptic polarization orientation of the reflected light. For example, different pit depth and different coating layer thickness change the relative angle difference between the orientation of the pit and the orientation of the principle axis of the reflected polarization ellipse.

In particular optical memory produced as discs the substrate is covered with a reflecting layer which is then further coated with a protective layer. In a preferred embodiment the protective layer used comprises non-birefringent material. Use of a non-birefrinent material is preferred to prevent alteration of the polarization ellipse.

Since in applications such as DVD discs, it is desirable to enable the use of different discs in the same player, it is useful to have the ability to calibrate the relative angle that the detection system is assuming in associating a detected polarization state with a specific pit orientation.

Such a calibration can be achieved by selecting a particular sector in the disc, referred to herein as “the calibration sector”, on which a representative known set of the used pits is written. The set of pits can be the full set pits used on the particular disc, or just a partial set of these pits.

Preferably a predetermined pattern is selected for pits on tracks neighboring the calibration sector.

Since in this calibration sector the order and orientation of all pits is predetermined, an initial reading of the polarization characteristics associated with each pit can serve to adjust the parameter values used in the detection system for associating a detected range of polarization states with a given pit geometry and orientation.

Method of Selecting the Set of Pit Orientations, so as to Reduce the Possibility of Off-Center Illumination of the Pit

To reduce reading errors and variations, it is desirable that the light beam illuminate the pit of interest at the center. In many prior art applications, such as DVD disc, the light beam continuously scans along a track on which pit marks are serially ordered.

Typically in prior art applications the pits were imprinted so that the long axis of the pit is parallel to the track. Consequently, a tracking deviation in which the center of the focused light beam is slightly off the center of the track, will inevitably result in the center of the beam not going above the middle point of the width of the pit.

In a preferred embodiment of the present invention, the sensitivity to tracking errors can be reduced by selecting the use of a set of pit orientations such that no pit is oriented parallel to the track.

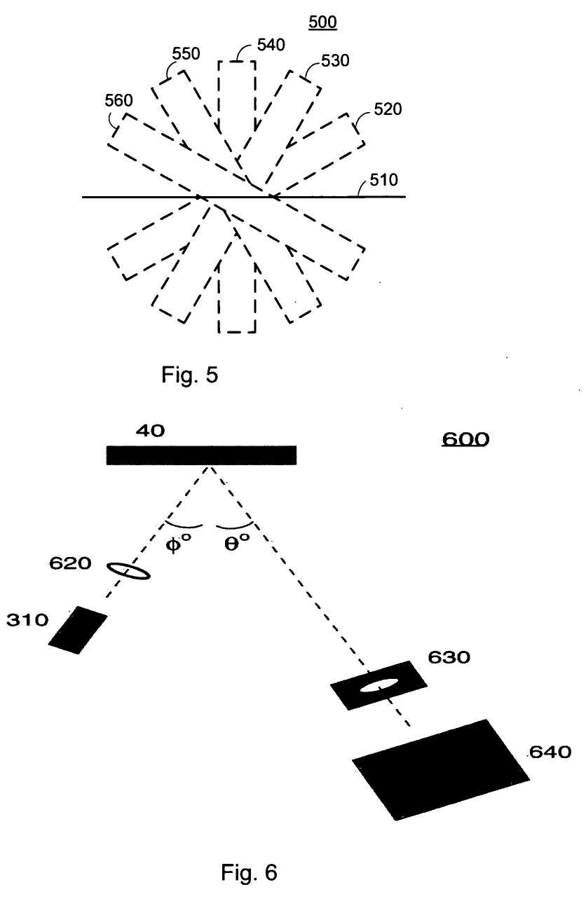

In FIG. 5 such a set is depicted. Line 510 denotes the geometrical direction of the track. All the pits 520, 530, 540, 550, 560, are oriented at an angle to the track.

In a preferred embodiment, the set of pits is evenly distributed among 180 degrees angles, and have a maximum angular deviation from the track. For example, for a set of six pit orientations, the pits will have a difference of 30 degrees between each of the possible orientations, and to be furthest from the track orientation taken to be at a zero angle. The preferred choice is thus of six pits at angles 15, 45, 75, 105, 135, 165 degrees to the track axis.

Preferred Pit Mark Dimensions

The dimensions of the preferred pit marks for applications such as optical memory discs are a compromise of several constraints. To have a significant potential of penetration of light to the bottom of the pit, the length of the pit should preferably be more than 2/3 of the illumination wavelength λ. Additionally, in order to have a high density of pits, the distance between pit is preferably not larger than 3/2 λ. Since in the present format the pits can point in a variety of orientations, the pit length is preferably between 2/3 λ and 3/2 λ. In an exemplary embodiment the pit lengths are between 550/650 λ and 700/650 λ.

For pits which are constructed for the purpose of producing reflected light with low eccentricity, the length and width of the pit should preferably be of the same size. i.e., a difference of not more than 30% between the length and the width of the pit.

To achieve significant ellipticity of the reflected light, a preferred embodiment is such that the pit widths are between 200/650 λ and 350/650 λ.

Method of Using the Stokes Parameters and their Conversion to Angles in Order to Define a Range of Parameters that Single Out a Specific Pit Mark from a Given Set of Pit Marks

As described above, in order to uniquely identify the central pit from the detector measurements, there must be a non-overlap of the detected ellipse domain. Here we shall further elaborate of an embodiment of how the domain of parameters is defined, and from it the identification of the pit.

When a beam of light is focused of a central pit there is residual illumination of the environment pits. Using a beam of circular polarization, the reflected light will be elliptically polarized. From the measurement of polarization states by an appropriate set of detectors, one may calculate the effective Stokes parameters at the selected viewing window of the detectors. From the Stokes parameters, one may determine the associated elliptic polarization characteristics of polarization orientation angle “γ”, the total intensity “I”, and the eccentricity “a/b”, by using equations (1)-(6). We shall refer to these obtained values as the “detected parameters”.

Let us focus first on pit orientation and the corresponding elliptic polarization orientation. We assume there is a pre-determined set of pits of different orientations. For a given pit at the focus, the collection of all possible neighbors give rise to a range of measured elliptic polarization orientations with respect to the pit orientation. We shall refer to this range as the “polarization orientation range”. A rotation of the central pit by a certain angle will cause the same angular rotation of the associated polarization orientation range. The width of the polarization orientation range remains the same.

In order to have the ability to infer the orientation of the pit at the beam focus from the detected polarization orientation, the difference in orientation between all pits in the set must be larger than the width of the “polarization orientation range”. It is preferred to have an even angular spacing of the pit orientations.

The same considerations apply to the range of detected intensity levels, which are associated with the pit surface area, (e.g, due to variation of the pit width).

In the case of using a set of pits is composed of several subsets of pits, each subset includes pits of uniform shape that differ only in orientation. In a preferred embodiment the subsets will be characterized by pits of different width.

It may be that the detected polarization orientation range will be different depending on the subset to which the central pit at the focus belongs. In such case, there may also be a difference in the preferred set of angles of orientation of pits in each subset, such that there will not be an overlap in the detected polarization orientation range associated with pits in the same set. On the other hand, there is no issue of overlap of associated polarization orientation ranges between pits belonging to different sets, since they can be distinguished by the difference in the associated measured intensity level.

When the above conditions are satisfied, there can be a unique identification of the central pit, at the focus of the beam, from the detected parameters. First, the intensity level identifies the width of the pit. Second, the eccentricity identifies whether the pit elongated type (high eccentricity) or a near circular type (low eccentricity). Third, for elongated pits, the pit orientation can be inferred from the measured polarization orientation.

It should be understood that each of the Stokes parameters, e.g., elliptical polarization orientation angle, is a computable function of the polarization detectors values, and hence its information content is identical to the associated collection of detectors measurement values. The representation of this information in the computed Stokes parameters has a geometrical meaning which is intuitive for the human mind to grasp and manipulate. Yet, in an automated detection algorithm, e.g., using computer hardware and software, the set of bare detector values can be directly used as an identifier of the central pit orientation, without the need to explicitly compute the Stokes parameter values. In an exemplary embodiment a neural network is used to directly determine the pit orientation.

Since there are three Stokes parameters, a minimum of three (3) detectors of different reflected polarization intensities are preferred. In the embodiments and illustrative drawings above we have used 4 detectors since for that particular choice of detectors the computation of the Stokes parameters, using equations (1)-(6), has the simplest analytical form. Yet, if the set of bare detector measurement values is directly used to identify the pit identity then the minimum number of three polarization detectors may be preferred. In such case, the most preferred choice of polarization detectors is at 60 degrees to one another.

An Embodiments Using a Single Detector and Using Linearly or Circular Polarized Light Source

The above has been described in particular in relation to a circular polarized light source in combination with multiple polarization detectors sufficient to obtain the information on the full elliptical polarization state. This is not meant to be limiting in any way and the invention is applicable also in relation to a linearly polarized light source and/or the detection of reflected light with a lesser number polarization detectors. Below we summarize the mathematical analysis of both linear and circular polarization embodiments, and highlight the advantages of using circular polarized light even when just one polarization detector is used. Let us assume that the incident beam, denoted A(t), is linearly polarized, and that the primary detector measures the intensity, of reflected light polarized in direction β which is at angle θ to the incident beam polarization. In another embodiment, a secondary detector which measures the polarization component in direction α, which is perpendicular to direction β, is added. In this embodiment, the total intensity is arrived by summing the output of the detectors in directions α and β.

To be specific, we shall analyze only the case where the β detector polarization is perpendicular to the incident beam polarization, i.e. θ=π/2. If there is no pit, then the β detector signal is zero. In contrast, if there is a pit the polarization rotation will lead to a β detector signal that is proportional to the amount of polarization rotation. Arbitrarily, we will define the x-axis as the axis along the length of the pit. In the event that the incident beam polarization a makes an angle Φ with the x-axis, the incident beam A(t), and the total intensity will be give by:
A(t)=\hat{x}Aₓ+ŷA_{y}=\hat{x}A cos(φ)+ŷA sin(φ)
I₀=Aₓ²+A_{y}²=A². Equations (7)

Hereafter, all definitions of coefficients and statements of intensity values are for the light collected at the detector which samples the light reflected in some limited direction. We define effective reflection coefficients Rₓ and R_{y} with respect to the pit orientation. The total reflected intensity, I_{TOT}^{R} is given by:

$$\begin{matrix}{I}_{tot}^{R} = {R}_{x}^{2} {A}_{x}^{2} + {R}_{y}^{2} {A}_{y}^{2} = {A}^{2} [ {R}_{x}^{2} {cos}^{2} ( ϕ ) + {R}_{y}^{2} {sin}^{2} ( ϕ ) ] . \\ The β detector signal can then be expressed by \text{:} & Equation ( 8 ) \\ {I}_{β}^{R} = [ - {R}_{x} {A}_{x} sin ( ϕ ) + {R}_{y} {A}_{y} {cos ( ϕ )}^{2} ] \\ \frac{{I}_{β}^{R}}{{I}_{0}} = {( {R}_{x} - {R}_{y} )}^{2} {cos}^{2} ( ϕ ) {sin}^{2} ( ϕ ) & Equation ( 9 )\end{matrix}$$

The ratio of equations 9 has unique values only in the range 0<Φ<π/4. By including the information of the total reflected intensity, I_{TOT}^{R}/I₀, resolution in the range of 0<Φ<π/2 orientations may be provided. Some resolution improvement may be further obtained by using the measure:

$$\frac{{I}_{β}^{R}}{{I}_{tot}^{R}} = \frac{{( {R}_{x} - {R}_{y} )}^{2} {cos}^{2} ( ϕ ) {sin}^{2} ( ϕ )}{{R}_{x}^{2} {cos}^{2} ( ϕ ) + {R}_{y}^{2} {sin}^{2} ( ϕ )} \qquad Equation ( 10 )$$

The detector signal is essentially a time average over the incident light, and we shall denote the average detector signal over time, as <F>. Defining the x-axis as the axis along the length of the rectangular pit, we decompose the light into a component Aₓ denoting the component whose polarization is along the x-axis and a component A_{y} denoting the component whose polarization is perpendicular to the x-axis. The incident beam A(t), and the total intensity, I₀, will be give by:
A(t)=\hat{x}Aₓ cos(wt)+ŷA_{y} sin(wt)
I₀=Aₓ² cos²(wt)+ŷA_{y}² sin²(wt)=A². Equations (11)

For the sake of demonstration, we shall limit our analysis to the case of circular polarized incident light (Aₓ=A_{y}, A=Aₓ+A_{y}) and the measurement of reflection by one polarization component detector. Let us define reflection coefficients Rₓ and R_{y} with respect to the pit orientation. For the sake of simplicity, we shall ignore reflection phase shifts, and just treat the simplest case of real reflection coefficients. The total reflected intensity is given by:

$$〈 {I}_{R} 〉 = {A}^{2} [ {R}_{x}^{2} ( {cos}^{2} ( wt ) 〉 + {R}_{y}^{2} 〈 {sin}^{2} ( wt ) 〉 ] = \frac{1}{2} {A}^{2} [ {R}_{x}^{2} + {R}_{y}^{2} ] \qquad Equation ( 12 )$$

Let us define the x-axis of detection as α, and the y-axis of detection as β, where α forms an angle Φ with the x-axis of the pit. In this case we will use two perpendicular linear polarized detectors, one aligned to detect polarization component α, denoted I_{α}^{R}, and a second aligned to detect polarization component β, denoted I_{β}^{R}. The total measured reflected intensity, denoted Iₜₒₜ^{R} is given by:

$$\frac{〈 {I}_{tot}^{R} 〉}{{I}_{0}} = \frac{〈 {I}_{α}^{R} 〉 + 〈 {I}_{β}^{R} 〉}{{I}_{0}} = \frac{1}{2} [ {R}_{x}^{2} + {R}_{y}^{2} ] \qquad Equation ( 13 )$$

and the ratio of measured polarization intensities is given by:

$$\frac{〈 {I}_{α}^{R} 〉}{〈 {I}_{β}^{R} 〉} = \frac{{R}_{x}^{2} {cos}^{2} ( ϕ ) + {R}_{y}^{2} {sin}^{2} ( ϕ )}{{R}_{x}^{2} {sin}^{2} ( ϕ ) + {R}_{y}^{2} {cos}^{2} ( ϕ )} \qquad Equation ( 14 )$$

It is to be noted that the beam amplitude, A, does not appear in the ratio of Equation 14, and that the angle Φ does not appear in Equation 13, the expression for the total reflected intensity Iₜₒₜ^{R}. Thus, the reflected polarization characteristics are independent of the reflected total intensity. Moreover, detection has unique value in the full range of 0<Φ<π orientations. For the case of a circularly polarized incident beam, the mathematical results can be summarized as: The reflected total intensity is independent of the reflected polarization characteristics. Therefore, these two degrees of freedom can be exploited independently. In particular, we can design the pits to have N states, by combining M intensity levels (determined possibly by pit width) and P polarization states (determined by pit orientation), so that N=M*P.

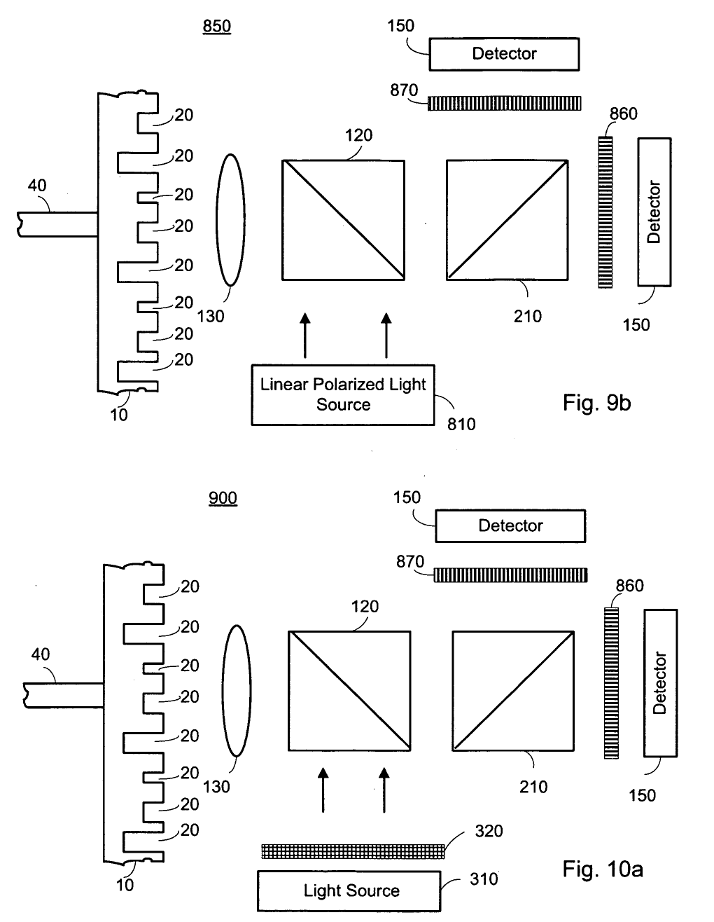

FIG. 9a illustrates a high level diagram of an optical memory system 800 according to an embodiment of the principle of the invention comprising a linear polarized light source and a linear polarized detector in accordance with the principle of the invention. Optical memory system 800 comprises linear polarized light source 810; lens 130; substrate 10 comprising a plurality of pits 20 and being rotatably secured on spindle 40; collimating lens 705; angular window mask 630; linear polarizer 820; and detector 150. In an exemplary embodiment linear polarized light source 810 comprises a laser diode. Lens 130 is arranged to channel light emitted by linear polarized light source 810 to illuminate pits 20 of substrate 10 from behind. Collimating lens 705 is arranged to channel light transmitted through pits 20 of substrate 10 to be incident through linear polarizer 820 on detector 150. Angular window mask 630 functions to improve discrimination of detector 150. In a preferred embodiment linear polarizer 820 exhibits polarization rotated 90° from the polarization of linear polarized light source 810. Preferably, pits 20 are of uniform depth.

In operation, linear polarized light source 810 emits light which is channeled by lens 130 to illuminate substrate 10 having a plurality of pits 20 imprinted thereon. Transmitted light, having encoded thereon the orientation of each of pits 20 as a polarization ellipse, is collimated collimating lens 705 and detected by detector 150 through linear polarizer 820. Utilizing a known baseline intensity, and Equations 7-10, the orientation encoding of pits 20 can be calculated as a function of the output of detector 150. FIG. 9a is illustrated as utilizing transmitted light, however this is not meant to be limiting in any way. Either reflected or transmitted light may be used without exceeding the scope of the invention.

FIG. 9b illustrates a high level diagram of an optical memory system 850 according to an embodiment of the principle of the invention utilizing a linearly polarized light and two detectors each detecting orthogonal linear polarizations of the output of the beam splitter. In particular, optical memory system 850 comprises linear polarized light source 810; first beam splitter 120; lens 130; substrate 10 comprising a plurality of pits 20 and being rotatably secured on spindle 40; second beam splitter 210; first linear polarizer 860; second linear polarizer 870; and first and second detectors 150. In an exemplary embodiment linear polarized light source 810 comprises a laser diode.

First beam splitter 120 and lens 130 are arranged to channel light emitted by linear polarized light source 810 to illuminate pits 20 of substrate 10. First beam splitter 120 and lens 130 are further arranged to channel light reflected from pits 20 of substrate 10 to be incident on second beam splitter 210. The first split output of second beam splitter 210 is channeled to first detector 150 through first linear polarizer 860. The second split output of second beam splitter 210 is channeled to second detector 150 through second linear polarizer 870. In a preferred embodiment first linear polarizer 860 exhibits polarization rotated 90° from the polarization of second linear polarizer 870. It will be noted that pits 20 are not required to be of uniform depth, as optical memory system 850 enables both depth and orientation encoding. Second beam splitter 210, first linear polarizer 860 and second linear polarizer 870 are shown as separate elements, however this is not meant to be limiting in any way. In particular the use of a Nicol prism, Wollaston prism or Glan-Thompson prism to act as a single element combining the functionality of second beam splitter 210, first polarizer 860 and second polarizer 870 is specifically included. In one embodiment the use of a combination element as described above may further require the use of a light spreading element such as an offset prism. Additionally combination elements often exhibit greater attenuation in one of the polarization paths as compared with the second polarization path. Compensation is preferably provided either through amplification of the greater attenuated path, or more preferably in the calculation of the polarization orientation based on the output of the detectors 150.

In operation, linear polarized light source 810 emits light which is channeled by first beam splitter 120 and lens 130 to illuminate substrate 10 having a plurality of pits 20 imprinted thereon. The reflection, having encoded thereon the orientation of each of pits 20, and optionally the pit depths, is channeled through first beam splitter 120 and then to second beam splitter 210 respectively to first and second detectors 150 through respective first and second linear polarizer 860, 870. Utilizing Equations 7-11, the orientation encoding of pits 20 can be calculated as a function of the output of detectors 150. Furthermore, the use of a plurality of detectors enables the decoding of both orientation of polarization ellipse 60 and depth information of pit 20. Thus, both depth and orientation encoding may be combined in a single pit mark 20. Optical memory system 850 has been described as utilizing reflected light incident directly onto substrate 10 however this is not meant to be limiting in any way. Optical memory system 850 may be designed to use transmitted light or to use reflected light at an angle as described above in relation to FIG. 6 without exceeding the scope of the invention.

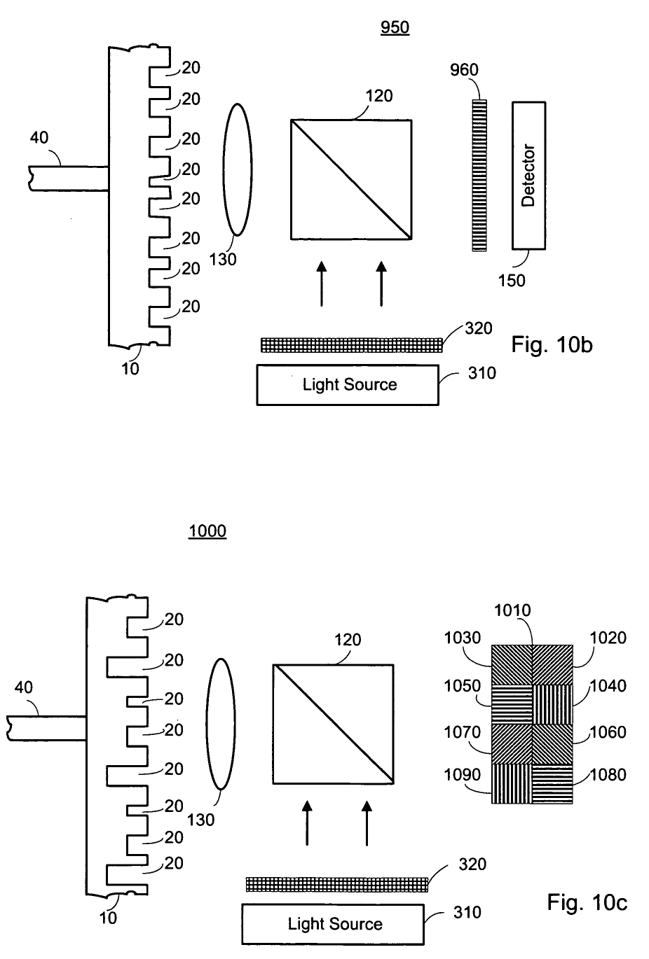

FIG. 10a illustrates a high level diagram of an optical memory system 900 according to an embodiment of the principle of the invention comprising a light source, a circular polarizer and a pair of linear polarized detectors. In particular, optical memory system 900 comprises light source 310; circular polarizer 320; first beam splitter 120; lens 130; substrate 10 comprising a plurality of pits 20 and being rotatably secured on spindle 40; second beam splitter 210; first linear polarizer 860; second linear polarizer 870; and first and second detectors 150. In an exemplary embodiment light source 310 comprises a laser diode.

First beam splitter 120 and lens 130 are arranged to channel circularly polarized light from light source 310 transmitted through circular polarizer 320 to illuminate pits 20 of substrate 10. Beam splitter 120 and lens 130 are further arranged to channel light reflected from pits 20 of substrate 10 to be incident on second beam splitter 210. The first split output of second beam splitter 210 is channeled to first detector 150 through first linear polarizer 860. The second split output of second beam splitter 210 is channeled to second detector 150 through second linear polarizer 870. In a preferred embodiment first linear polarizer 860 exhibits polarization rotated 90° from the polarization of second linear polarizer 870. It will be noted that pits 20 need not be of a uniform depth, as optical memory system 900 enables both depth and orientation encoding. Second beam splitter 210, first polarizer 860 and second polarizer 870 are shown as separate elements, however this is not meant to be limiting in any way. In particular the use of a Nicol prism, a Wollaston prism or a Glan-Thompson prism to act as a single element combining the functionality of second beam splitter 210, first polarizer 860 and second polarizer 870 is specifically included. In one embodiment the use of a combination element as described above may further require the use of a light spreading element such as an offset prism. Additionally combination elements often exhibit greater attenuation in one of the polarization paths as compared with the second polarization path. Compensation is preferably provided either through amplification of the greater attenuated path, or more preferably in the calculation of the polarization orientation based on the output of the detectors 150.

In operation, light source 310 emits light which is circularly polarized by circular polarizer 320 and then channeled by first beam splitter 120 and lens 130 to illuminate substrate 10 having a plurality of pits 20 imprinted thereon. The reflection, having encoded thereon the orientation of each of pits 20, and optionally the pit depths, is channeled through first beam splitter 120 and second beam splitter 210 respectively to first and second detectors 150 through respective first and second linear polarizer 860,870. Utilizing Equations 7-10, the orientation encoding of pits 20 can be calculated as a function of the output of detectors 150. Furthermore, the use of a plurality of detectors enables the decoding of both orientation of polarization ellipse 60 and depth information of pit 20. Thus, both depth and orientation encoding may be combined in a single pit mark 20.

Optical memory system 900 has been described as utilizing reflected light incident directly onto substrate 10 however this is not meant to be limiting in any way. Optical memory system 900 may be designed to use transmitted light or to use reflected light at an angle as described above in relation to FIG. 6 without exceeding the scope of the invention.

FIG. 10b illustrates a high level diagram of an optical memory system 950 according to an embodiment of the principle of the invention utilizing circularly polarized light and a single linear polarized detector. Optical memory system 950 comprises light source 310; circular polarizer 320; beam splitter 120; lens 130; substrate 10 comprising a plurality of pits 20 and being rotatably secured on spindle 40; linear polarizer 960; and detector 150. In an exemplary embodiment light source 310 comprises a laser diode. Beam splitter 120 and lens 130 are arranged to channel light circular polarized light from light source 310 to illuminate pits 20 of substrate 10. Beam splitter 120 and lens 130 are further arranged to channel light reflected from pits 20 of substrate 10 to be incident through polarizer 140 on detector 150. Preferably, pits 20 are of uniform depth.

In operation, light source 310 emits light which is circularly polarized by circular polarized 320 and channeled by beam splitter 120 and lens 130 to illuminate substrate 10 having a plurality of pits 20 imprinted thereon. Reflected light, having encoded thereon the orientation of each of pits 20 as a polarization ellipse, is detected by detector 150 through linear polarizer 140. Utilizing a known baseline intensity, and Equations 7-10, the orientation encoding of pits 20 can be calculated as a function of the output of detector 150.

Optical memory system 950 has been described as utilizing reflected light incident directly onto substrate 10 however this is not meant to be limiting in any way. Optical memory system 950 may be designed to use transmitted light or to use reflected light at an angle as described above in relation to FIG. 6 without exceeding the scope of the invention.

FIG. 10c illustrates a high level diagram of an optical memory system 1000 according to an embodiment of the principle of the invention comprising a circularly polarized light source and an array of orthogonally polarized pairs of detectors, each pair being associated with a particular one of each of the possible orientations of a mark 20. In particular, optical memory system 1000 comprises light source 310; circular polarizer 320; beam splitter 120; lens 130; substrate 10 comprising a plurality of pits 20 and being rotatably secured on spindle 40; and polarized detector array 1010 comprising polarized detectors 1020, 1030, 1040, 1050, 1060, 1070, 1080 and 1090. In an exemplary embodiment light source 310 comprises a laser diode. Polarized detector array 1010 comprises pairs of polarized detectors, with each member of the pair being polarized orthogonally to the other member of the pair. A pair of detectors is associated with each possible orientation of pit mark 20. A pair of orthogonal polarized detectors is thus operable to detect polarization ellipse 60 of each of the possible orientations.

Beam splitter 120 and lens 130 are arranged to channel circularly polarized light from light source 310 to illuminate pits 20 of substrate 10. Beam splitter 120 and lens 130 are further arranged to channel light reflected from pits 20 of substrate 10 to be incident on polarized detector array 1010. It will be noted that pits 20 need not be of a uniform depth, as optical memory system 1000 enables both depth and orientation encoding.

In operation, light source 310 emits light which is circularly polarized by circular polarizer 320 and then channeled by beam splitter 120 and lens 130 to illuminate substrate 10 having a plurality of pits 20 imprinted thereon. The reflection, having encoded thereon the orientation of each of pits 20, and optionally the pit depths, is channeled through beam splitter 120 to polarized detector array 1010. Utilizing Equations 11-14, the orientation encoding of pits 20 can be calculated as a function of the output of polarized detectors 1010, 1020, 1030, 1040, 1050, 1060, 1070, 1080 and 1090. The pair of orthogonally polarized detectors having a maximum output is preferably utilized to decode the polarization ellipse. Furthermore, the use of a plurality of detectors enables the decoding of both orientation of polarization ellipse 60 and depth information of pit 20. Thus, both depth and orientation encoding may be combined in a single pit mark 20.

Optical memory system 1000 has been described as utilizing reflected light incident directly onto substrate 10 however this is not meant to be limiting in any way. Optical memory system 1000 may be designed to use transmitted light or to use reflected light at an angle as described above in relation to FIG. 6 without exceeding the scope of the invention.

The invention further provides for an optical recording apparatus, preferably comprising one of an electron beam and a laser for recording an optically readable mark at an operative wavelength. The optically readable mark so recorded exhibits a predetermined length, a width less than the operative wavelength and one of a plurality of orientations in relation to a common axis.

Thus the present embodiments enable encoding data in an optical memory by planar orientation of marks, such as pits or bumps. The marks are sized to be of sub-wavelength width, with a length comparable to, or larger than, the wavelength. A polarized light source is used to read the mark, typically by reflection. Collected light exhibits an elliptic anisotropy, with the principle axis of the ellipse corresponding to the planar orientation of the mark. The collected light is detected by a plurality of polarization sensitive detectors, the intensity and polarization pattern of the collected light indicating the direction of the axis of the ellipse. Thus, the varying planar orientation of the mark encodes the data.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

We claim:

1. An optical storage medium designed to be readable with light of a pre-determined wavelength, the optical storage medium comprising:
a substrate; and
a plurality of optically detectable marks imprinted on said substrate, each of said plurality of optically detectable marks exhibiting:
a predetermined length;
a width less than the pre-determined wavelength; and
one of a plurality of orientations in relation to a common axis,
wherein information is stored on the optical storage medium at least partially as a function of said one of a plurality of orientations.

2. An optical storage medium according to claim 1, wherein said optically detectably marks alter the polarization characteristics of an incident polarized light of the predetermined wavelength, said altered polarization characteristics being detectable by at least one detector.

3. An optical storage medium according to claim 1, wherein said substrate comprises a circular platter with a center spindle hole, said circular platter comprising at least one reflective layer.

4. An optical storage medium according to claim 3, wherein said substrate further comprises a coating layer above said at least one reflective layer, said coating layer being substantially non-birefringent.

5. An optical storage medium according to claim 3, wherein said common axis is a spiral track, said spiral track being radially centered on a center spindle hole.

6. An optical storage medium according to claim 1, wherein said optically detectable marks comprise pits.

7. An optical storage medium according to claim 6, wherein said predetermined length is between 2/3 and 3/2 of the pre-determined wavelength.

8. An optical storage medium according to claim 6, wherein said predetermined length is between 550/650 and 700/650 of the pre-determined wavelength.

9. An optical storage medium according to claim 1, wherein said common axis comprises a spiral track and said optically detectable marks are separated by a minimum distance between the centers of successive optically detectable marks along the same track of greater than 7/6 of the pre-determined wavelength.

10. An optical storage medium according to claim 1, wherein said common axis comprises a spiral track and said optically detectable marks are separated by a minimum distance between the centers of successive optically detectable marks along the same track of greater than 8/6 of the pre-determined wavelength.

11. An optical storage medium according to claim 1, wherein said common axis comprises a spiral track and centers of said optically detectable marks of a given track of said spiral track exhibit a distance from centers of optically detectable marks of neighboring tracks of said spiral track greater than 7/6 of the pre-determined wavelength.

12. An optical storage medium according to claim 1, wherein said common axis comprises a spiral track and centers of said optically detectable marks of a given track of said spiral track exhibit a distance from centers of optically detectable marks of neighboring tracks of said spiral track greater than 8/6 of the pre-determined wavelength.

13. An optical storage medium according to claim 1, wherein said plurality of orientations are evenly distributed in relation to said common axis, said plurality of orientations further exhibiting a maximum angular deviation from said common axis.

14. An optical storage medium according to claim 1, wherein said width of each of said plurality of optically detectable marks is selected from a plurality of widths, and wherein information is stored on the optical storage medium at least partially as a function of said selected one of a plurality of widths.

15. An optical storage medium according to claim 1, wherein said optically detectable marks exhibit a width less than 50% of the pre-determined wavelength.

16. An optical storage medium according to claim 1, wherein said optically detectable marks exhibit a width less than 40% of the pre-determined wavelength.

17. An optical storage medium according to claim 1, wherein said optically detectable marks exhibit a width less than 33% of the pre-determined wavelength.

18. An optical storage medium according to claim 1, wherein said marks comprise pits having a plurality of respective pit depths, and wherein information is stored on the optical storage medium at least partially as a function of said selected pit depths.

19. An optical storage medium according to claim 1, wherein said plurality of optically detectable marks imprinted on said substrate are placed in a regular pattern of locations, a mark being placed in each of locations.

20. An optical storage medium according to claim 1, wherein said plurality of optically detectable marks imprinted on said substrate are selected such that the set of marks immediately adjacent any of said plurality of optically detectable marks are not all of the same orientation.

21. A method of optical recording of data to be readable with light of a pre-determined wavelength, the method comprising:
providing a substrate; and
imprinting on said substrate a plurality of optically detectable marks, each of said plurality of optically detectable marks exhibiting:
a predetermined length;
a width less than the pre-determined wavelength; and
one of a plurality of orientations in relation to a common axis,
information being encoded by said selection of one of a said plurality of orientations.

22. A method of optical recording of data to be readable with light of a pre-determined wavelength, the method comprising:
providing a substrate; and
imprinting on said substrate a plurality of optically detectable marks, each of said plurality of optically detectable marks exhibiting:
a predetermined length;
one of a plurality of widths, each of said plurality of width being less than the pre-determined wavelength; and
one of a plurality of orientations in relation to a common axis,
wherein information is encoded by a selection of one of a said plurality of orientations in combination with one of said plurality of widths.

23. An optical information reading apparatus comprising:
an optical storage medium comprising a plurality of optically detectable marks having data encoded at least partially as a function of the orientation of each of said optically detectable marks, said marks exhibiting a single pre-determined length and a width less than a pre-determined wavelength;
a polarized light source outputting light of said pre-determined wavelength;
a means for focusing the output light on one of said plurality of optically detectable marks; and
a means for detecting an orientation of a polarization ellipse as a consequence of said focused light of said pre-determined wavelength having interacted with said mark of said optical storage medium.

24. An optical information reading apparatus according to claim 23, wherein said means for detection an orientation comprises at least three polarization detectors each detecting the polarization in a different orientation from the others.

25. An optical information reading apparatus in accordance with claim 24, wherein said means for detection of an orientation comprises an orientation determiner in communication with said at least three polarization detectors, said apparatus further comprising:
an intensity determiner in communication with said at least three polarization detectors; and
an ellipticity determiner in communication with said at least three polarization detectors,
said orientation determiner being operable to detect said orientation of each one of said plurality of optically detectable marks as a function of said at least three polarization detectors,
said intensity determiner being operable to detect said width of each of said plurality of optically detectable marks as a function of said at least three polarization detectors, and
said ellipticity determiner being operable to detect an aspect ratio of each of said plurality of optically detectable marks as a function of said at least three polarization detectors.

26. An optical information reading apparatus according to claim 24, wherein said orientation of said mark is determined from the output of said at least three polarization detectors.

27. An optical storage reader for use with an optical storage medium comprising a plurality of optically detectable marks having data encoded at least partially as a function of the orientation of each of said optically detectable marks, each of the optically detectable marks having a width smaller than a pre-determined wavelength, the optical storage reader comprising:
a polarized light source emitting light of the pre-determined wavelength, said polarized light source optically impacting each of the plurality of optically detectable marks of the optical storage medium thereby generating a polarization ellipse having an axis associated with the orientation of each of the optically detectable marks; and
at least one polarized detector, said at least one polarized detector detecting said orientation of said polarization ellipse thereby optically reading the encoded data of each of the optically detectable marks.

28. An optical storage reader according to claim 27, said polarized light source comprising one of a linear polarized light source and a circular polarized light source.

29. An optical storage reader according to claim 27, said polarized light source being a linear polarized light source, and said at least one polarized detector being a linear polarized detector.

30. An optical storage reader according to claim 29, wherein said at least one polarized detector is aligned to exhibit polarization at 90° to the linear polarization of said linear polarized light source.

31. An optical storage reader according to claim 27, further comprising a splitter said splitter receiving said polarization ellipse, said at least one polarized detector comprising a plurality of linear polarized detectors in optical communication with said splitter.

32. An optical storage reader according to claim 31, wherein said plurality of linear polarized detectors comprise two linear polarized detectors having linear polarizations oriented at 90° to each other.

33. An optical storage reader according to claim 27, wherein said at least one polarized detector comprises a plurality of pairs of polarized detectors, each of said pairs being associated with a unique one of said orientations of said polarization ellipse.

34. An optical storage reader according to claim 33, wherein said pairs of polarized detectors comprise two linear polarized detectors having linear polarizations oriented at 90° to each other.

35. An optical storage reader according to claim 27, wherein said at least one polarized detector comprises at least three linear polarized detectors.

36. An optical storage reader according to claim 35, wherein said at least three linear polarized detectors are arranged to detect the Stokes parameters of said polarization ellipse.

37. An optical storage reader according to claim 27, wherein said at least one polarized detector comprises at least 4 linear polarized detectors arranged to characterize said polarization ellipse.

38. An optical storage reader according to claim 37, where said characterization of said polarization ellipse includes utilizing the Stokes parameters.
